(19) United States
(12) Patent Application Publication
(10) Pub. No.: US 2021/0276398 A1
(43) Pub. Date: Sep. 9, 2021

(54) VEHICLE HEAT EXCHANGE SYSTEM

(71) Applicant: DENSO CORPORATION, Kariya-city (JP)

(72) Inventors: Kengo KAZARI, Kariya-city (JP); Takahiro UNO, Kariya-city (JP)

(21) Appl. No.: 17/328,570

(22) Filed: May 24, 2021

Related U.S. Application Data
(63) Continuation of application No. PCT/JP2019/047487, filed on Dec. 4, 2019.

(30) Foreign Application Priority Data
Dec. 14, 2018 (JP) 2018-234415
Nov. 18, 2019 (JP) 2019-207741

(51) Int. Cl. B60H 1/00; B60K 11/04; B60K 11/08

(52) U.S. Cl. CPC B60H 1/00921; B60K 11/04; B60H 2001/00928; B60H 1/00321; B60K 11/085

(57) ABSTRACT

A heat exchange system includes a heat exchanger, a radiator, a connecting member, a shutter, and a controller. The heat exchanger is configured to exchange heat between a heat medium circulating through a heat exchange cycle and an air introduced into an engine compartment. The radiator is configured to exchange heat between a cooling water and the air. The connecting member thermally connects between the heat exchanger and the radiator. The shutter is configured to selectively allow and prevent supply of air to the heat exchanger and the radiator. The controller is configured to determine whether a required heat absorption amount of the heat exchanger can be supplemented by a required heat dissipation amount of the radiator, and control the shutter to move in a closing direction upon determining that the required heat absorption amount can be supplemented by the required heat dissipation amount.

### CROSS REFERENCE TO RELATED APPLICATION

The present application is a continuation application of International Patent Application No. PCT/JP2019/047487 filed on Dec. 4, 2019, which designated the U.S. and claims the benefit of priority from Japanese Patent Application No. 2018-234415 filed on Dec. 14, 2018, and Japanese Patent Application No. 2019-207741 filed on Nov. 18, 2019. The entire disclosures of all of the above applications are incorporated herein by reference.

### TECHNICAL FIELD

The present disclosure relates to a vehicle heat exchange system.

### BACKGROUND ART

In a vehicle, an air is introduced into an engine compartment through a grill opening and supplied to a radiator and an outside heat exchanger of a vehicular air-conditioner. A heat exchange system includes a blower configured to supply the air introduced through the grill opening to the outside heat exchanger and the radiator.

### SUMMARY

A heat exchange system includes a heat exchanger, a radiator, a connecting member, and a shutter. The heat exchanger is used for a heat exchange cycle of an air-conditioner of a vehicle. The heat exchanger is configured to exchange heat between a heat medium circulating through the heat exchange cycle and an air introduced from a front side of the vehicle into an engine compartment such that the heat medium absorbs heat from the air or dissipate heat to the air. The radiator is used for a cooling system configured to cool a heat source in the vehicle. The radiator is configured to exchange heat between a cooling water for cooling the heat source in the vehicle and the air introduced from the front side of the vehicle into the engine compartment. The connecting member thermally connects between the heat exchanger and the radiator. The shutter is configured to selectively allow and forbid an air to be supplied to the heat exchanger and the radiator.

### BRIEF DESCRIPTION OF DRAWINGS

FIG. 1 is a block diagram of a schematic configuration of a vehicle heat exchange system of a first embodiment.

FIG. 2 is a schematic diagram of a configuration of a vehicle of the first embodiment.

FIG. 3 is a block diagram illustrating an operation example of the vehicle heat exchange system of the first embodiment.

FIG. 4 is a perspective cross-sectional view of a radiator, an outside heat exchanger, and fins of the first embodiment.

FIG. 5 is a graph showing a comparison of power consumptions of the vehicle of the first embodiment between a case a shutter is open and a case the shutter is closed.

FIG. 6 is a block diagram showing an electrical configuration of the vehicle heat exchange system of the first embodiment.

FIG. 7 is a flowchart showing a procedure of a process executed by an air-conditioner ECU of the first embodiment.

FIG. 8 is a flowchart showing a procedure of processing executed by a cooling ECU of the first embodiment.

FIG. 9 is a flowchart showing a procedure of a process executed by a shutter ECU of the first embodiment.

FIG. 10 is a graph showing a relationship between a heat transfer amount between the radiator and the outside heat exchanger of the first embodiment and a speed of air passing through them.

FIG. 11 is a flowchart showing a procedure of a process executed by a shutter ECU of a second embodiment.

FIG. 12 is a flowchart showing a procedure of a process executed by an air-conditioner ECU of a third embodiment.

FIG. 13 is a schematic diagram of a configuration of a vehicle of another embodiment.

### DESCRIPTION OF EMBODIMENT

To begin with, examples of relevant techniques will be described.

In a vehicle, an air is introduced into an engine compartment through a grill opening and supplied to a radiator and an outside heat exchanger of a vehicular air-conditioner. Through the outside heat exchanger, a heat medium of a refrigeration cycle or a heat pump cycle of the vehicular air-conditioner flows. The outside heat exchanger is configured to exchange heat between the heat medium flowing through the outside heat exchanger and the air, thereby dissipating heat of the heat medium to the air or absorbing heat of the air into the heat medium. Through the radiator, a cooling water for cooling an internal combustion engine flows. The radiator is configured to exchange heat between the cooling water flowing through the radiator and the air, thereby dissipating heat of the cooling water to the air.

The vehicle may include a shutter configured to temporarily restrict an air from flowing into the engine compartment through the grill opening.

For example, the heat exchange system includes a blower configured to supply the air introduced through the grill opening to the outside heat exchanger and the radiator. The blower is usually rotated in a forward direction so that the air introduced through the grill opening flows toward the outside heat exchanger and the radiator. In this case, the outside heat exchanger is used as an evaporator of a heat pump cycle. When the outside heat exchanger serves as the evaporator, water contained in the air may condense on an outer surface of the outside heat exchanger, which may generate frost on the outer surface of the outside heat exchanger. In the heat exchange system, when the frost is generated on the outside heat exchanger, a defrosting operation for removing the frost from the outside heat exchanger is performed. Specifically, in this heat exchanger system, the shutter for the grill opening is closed and the blower is rotated in a reverse direction during the defrosting operation. As a result, the air warmed by the radiator is blown to the outside heat exchanger and the frost on the outside heat exchanger is removed.

In a configuration in which the blower is rotated in the reverse direction to transfer heat of the radiator to the outside heat exchanger, a power to rotate the blower in the reverse direction is required and a power consumption of the vehicle may increase.

It should be noted that such issue is not limited to the heat exchange system that drives the blower during the defrosting operation, but this issue is common between heat exchange systems that drive the blower when heat-exchanging between the outside heat exchanger and the radiator.

It is objective of the present disclosure to provide a heat exchange system of a vehicle that can reduce a power consumption.

A heat exchange system according to one aspect of the present disclosure includes a heat exchanger, a radiator, a connecting member, and a shutter. The heat exchanger is used for a heat exchange cycle of an air-conditioner of a vehicle. The heat exchanger is configured to exchange heat between a heat medium circulating through the heat exchange cycle and an air introduced from a front side of the vehicle into an engine compartment such that the heat medium absorbs heat from the air or dissipate heat to the air. The radiator is used for a cooling system configured to cool a heat source in the vehicle. The radiator is configured to exchange heat between a cooling water for cooling the heat source in the vehicle and the air introduced from the front side of the vehicle into the engine compartment. The connecting member thermally connects between the heat exchanger and the radiator. The shutter is configured to selectively allow and forbid an air to be supplied to the heat exchanger and the radiator.

According to this configuration, since the heat exchanger and the radiator are thermally connected through the connecting member, heat can be effectively transferred between the heat exchanger and the radiator when the shutter blocks an airflow to the heat exchanger and the radiator. Thus, even if it is necessary to rotate a blower to exchange heat between the heat exchanger and the radiator, a rotational speed of the blower can be reduced. Further, it is also possible to stop the blower depending on conditions. Therefore, power consumption can be reduced.

Hereinafter, an embodiment of the vehicle heat exchange system will be described with reference to the drawings. In order to facilitate understanding of the description, the same reference numerals are assigned to the same components in the respective drawings as much as possible, and a repetitive description of the same components will be omitted.

### First Embodiment

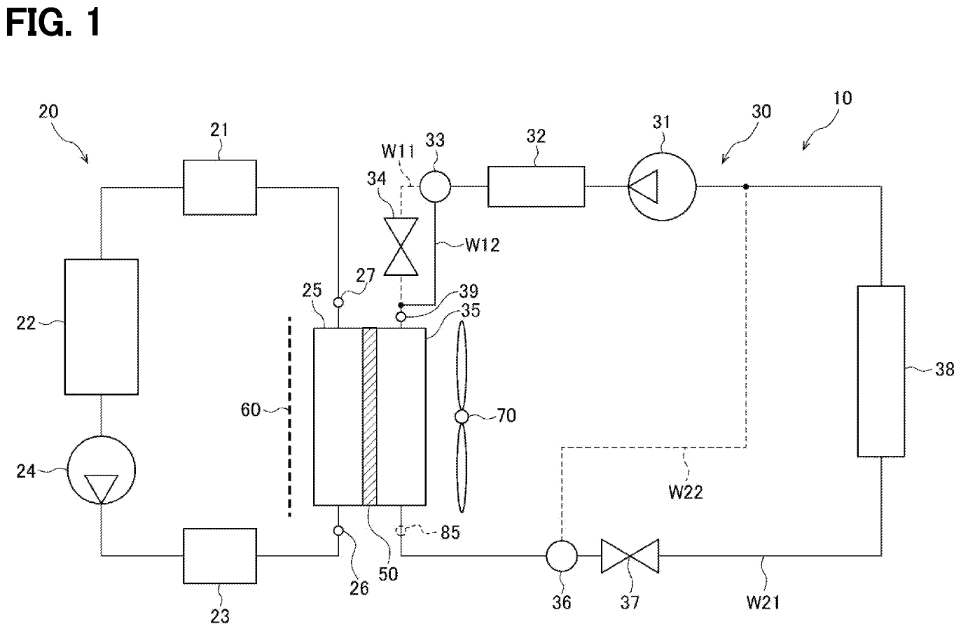

First, a first embodiment of a vehicle heat exchange system 10 shown in FIG. 1 will be described. A vehicle in which the heat exchange system 10 of the present embodiment is mounted is an electric vehicle, a plug-in hybrid vehicle, or the like that travels with power of an electric motor. As shown in FIG. 1, the vehicle heat exchange system 10 of the present embodiment includes a cooling system 20 and a heat pump cycle 30.

The cooling system 20 is a system configured to cool a motor generator 21, a battery 22, and an inverter 23 mounted in the vehicle by circulating a cooling water through these elements. As described above, heat generating sources targeted by the cooling system 20 of the present embodiment are the motor generator 21, the battery 22, and the inverter 23.

The motor generator 21 is driven by electric power supplied from the battery 22. The power of the motor generator 21 is transmitted to wheels of the vehicle, so that the vehicle travels. Further, the motor generator 21 generates regenerative power based on kinetic energy transmitted from the wheels when the vehicle is stopped. The electric power of the motor generator 21 generated by the regenerative power generation is charged in the battery 22.

The battery 22 is made of a secondary battery that can be charged and discharged, such as a lithium ion battery. The electric power charged in the battery 22 is supplied not only to the motor generator 21 but also to various electronic devices mounted in the vehicle.

The inverter 23 converts DC power charged in the battery 22 into AC power and supplies the AC power to the motor generator 21. Further, the inverter 23 converts AC power generated through the regenerative power generation of the motor generator 21 into DC power and charges the battery 22.

The cooling system 20 includes a pump 24 and a radiator 25. The cooling system 20 has a structure in which the motor generator 21, the battery 22, the pump 24, the inverter 23, and the radiator 25 are annularly connected with pipes. In the cooling system 20, the cooling water circulates through the pipes connecting between the elements.

The pump 24 is a so-called electric pump configured to operate based on electric power supplied from the battery 22. The pump 24 is configured to circulate the cooling water through each element in the cooling system 20 by pumping the cooling water circulating through the cooling system 20.

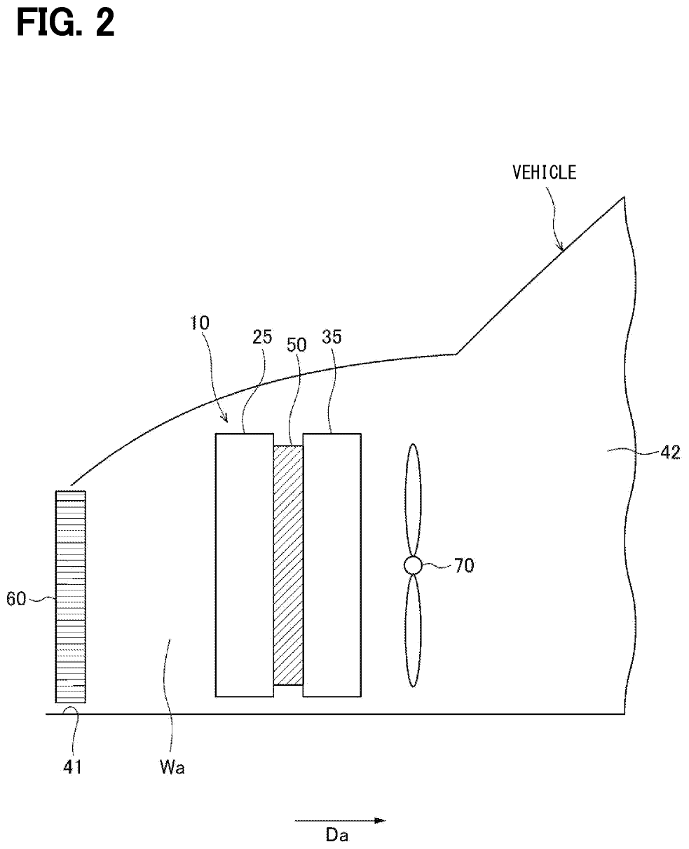

As shown in FIG. 2, the radiator 25 is arranged in a middle of an air passage Wa extending from a grill opening 41 defined in a front portion of the vehicle to an engine compartment 42. The radiator 25 is configured to cool the cooling water by exchanging heat between the cooling water flowing through the radiator 25 and an air introduced into the engine compartment 42 through the grill opening 41 and releasing heat of the cooling water to the air.

As shown in FIG. 1, in the cooling system 20, the cooling water cooled by the radiator 25 circulates through the motor generator 21, the battery 22, and the inverter 23, and heat of these elements is absorbed by the cooling water. As a result, the motor generator 21, the battery 22, and the inverter 23 are cooled.

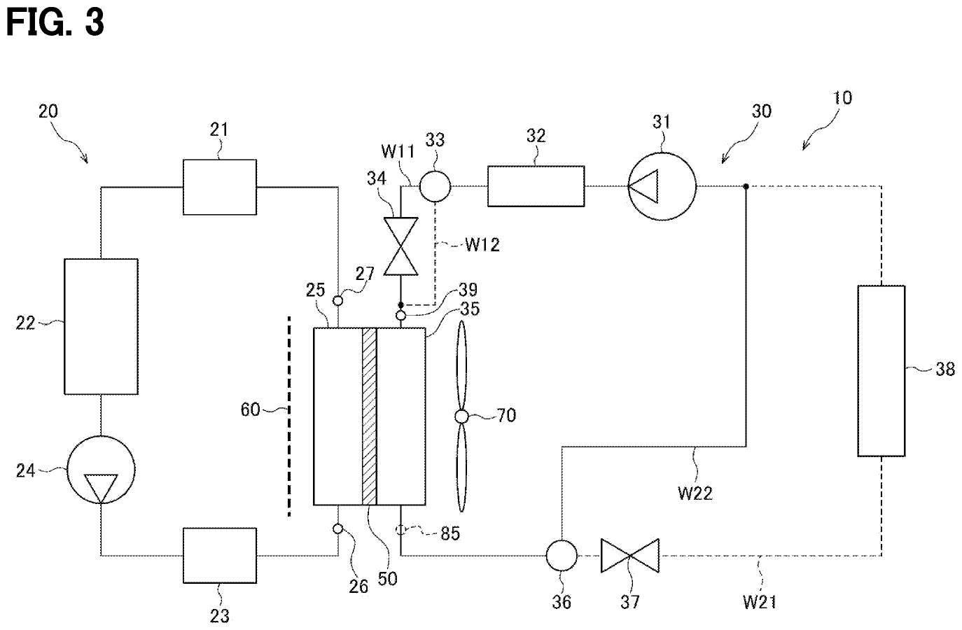

The heat pump cycle 30 is a system of an air-conditioner configured to heat and cool air to be supplied into the vehicle compartment. In this embodiment, the heat pump cycle 30 corresponds to a heat exchange cycle of an air-conditioner. As shown in FIG. 1, the heat pump cycle 30 includes a compressor 31, an inside radiator 32, a first three-way valve 33, a first expansion valve 34, an outside heat exchanger 35, a second three-way valve 36, a second expansion valve 37, and an evaporator 38. The heat pump cycle 30 has a structure in which these elements are annularly connected with pipes. In the heat pump cycle 30, a heat medium circulates through the pipes connecting between the elements. The heat pump cycle 30 can operate in a cooling mode for cooling a conditioned air and in a heating mode for heating the conditioned air. Solid lines in FIG. 1 shows pipes through which the heat medium flows when the heat pump cycle 30 is operating in the cooling mode and broken lines in FIG. 1 shows pipes through which the heat medium does not flow in the cooling mode. Further, solid lines in FIG. 3 shows pipes through which the heat medium flows when the heat pump cycle 30 is operating in the heating mote and broken lines in FIG. 3 shows pipes thorough which the heat medium does not flow in the heating mode.

The compressor 31 is configured to draw and compress the heat medium and discharge the compressed heat medium to the inside radiator 32.

When the heat pump cycle 30 is operating in the heating mode, the inside radiator 32 is configured to heat the conditioned air by releasing heat to the conditioned air from the heat medium discharged out of the compressor 31. The heat medium having flown through the inside radiator 32 flows into the first three-way valve 33.

The first three-way valve 33 is configured to selectively flow the heat medium flowing from the inside radiator 32 to either one of a passage W11 or a bypass passage W12. The passage W11 is a passage in which the first expansion valve 34 is arranged. The bypass passage W12 is a passage that bypasses the first expansion valve 34. As shown in FIG. 1, when the heat pump cycle 30 is operating in the cooling mode, the first three-way valve 33 allows the heat medium flowing from the inside radiator 32 to flow through the bypass passage W12. Further, as shown in FIG. 3, when the heat pump cycle 30 is operating in the heating mode, the first three-way valve 33 allows the heat medium flowing from the inside radiator 32 to flow through the passage W11.

When the heat pump cycle 30 is operating in the heating mode, the first expansion valve 34 expands and decompresses the heat medium flowing from the inside radiator 32 into the passage W11.

The heat medium having passed through the passage W11 and the first expansion valve 34 or the heat medium having passed through the bypass passage W12 and bypassed the first expansion valve 34 flows into the outside heat exchanger 35. As shown in FIG. 2, the outside heat exchanger 35 is arranged in a middle of the air passage Wa extending from the grill opening 41 to the engine compartment 42, similarly to the radiator 25. The outside heat exchanger 35 is arranged at a position downstream of the radiator 25 in an airflow direction Da. When the heat pump cycle 30 is operating in the cooling mode as shown in FIG. 1, the outside heat exchanger 35 serves as a condenser for cooling the heat medium circulating therethrough. That is, the outside heat exchanger 35 exchanges heat between the heat medium and an air and releases heat of the heat medium to the air. Further, when the heat pump cycle 30 is operating in the heating mode as shown in FIG. 3, the outside heat exchanger 35 serves as an evaporator for heating the heat medium. That is, the outside heat exchanger 35 exchanges heat between the heat medium flowing therethrough and an air and the heat medium absorbs heat of the air. The heat medium having flown through the outside heat exchanger 35 flows into the second three-way valve 36.

The second three-way valve 36 is configured to selectively flow the heat medium from the outside heat exchanger 35 to either one of a passage W21 or a bypass passage W22. The passage W21 is a passage in which the second expansion valve 37 and the evaporator 38 are arranged. The bypass passage W22 is a passage that bypasses the second expansion valve 37 and the evaporator 38. As shown in FIG. 1, when the heat pump cycle 30 is operating in the cooling mode, the second three-way valve 36 allows the heat medium flowing from the outside heat exchanger 35 to flow into the passage W21. Further, as shown in FIG. 3, when the heat pump cycle 30 is operating in the heating mode, the second three-way valve 36 allows the heat medium flowing from the outside heat exchanger 35 to flow into the bypass passage W12.

When the heat pump cycle 30 is operating in the cooling mode, the second expansion valve 37 expands and decompresses the heat medium flowing from the outside heat exchanger 35. The heat medium decompressed by the second expansion valve 37 flows into the evaporator 38. The evaporator 38 is configured to cool the conditioned air by exchanging heat between the heat medium flowing through the evaporator 38 and the conditioned air and absorbing heat of the conditioned air into the heat medium.

Next, an operation example of the heat pump cycle 30 will be specifically described.

As shown in FIG. 1, when the heat pump cycle 30 is operating in the cooling mode, the heat medium circulates through “the compressor 31, the inside radiator 32, the outside heat exchanger 35, the second expansion valve 37, the evaporator 38, and the compressor 31” in this order. In this case, in the heat pump cycle 30, the high-temperature high-pressure heat medium discharged from the compressor 31 flows into the inside radiator 32. At this time, the conditioned air is not allowed to flow to the inside radiator 32 in the air-conditioner, so that the heat medium flowing through the inside radiator 32 does not exchange heat with the conditioned air and flows into the outside heat exchanger 35.

The outside heat exchanger 35 serves as the condenser when the heat pump cycle 30 is operating in the cooling mode. That is, in the outside heat exchanger 35, the high-temperature high-pressure heat medium flowing through the outside heat exchanger 35 exchanges heat with an air, so that heat of the heat medium is dissipated to the air and the heat medium is cooled and condensed.

The heat medium cooled in the outside heat exchanger 35 is decompressed to have a low pressure by the second expansion valve 37 and flows into the evaporator 38. In the evaporator 38, the low-pressure heat medium flowing through the evaporator 38 exchanges heat with the conditioned air flowing outside of the evaporator 38, so that heat of the conditioned air is absorbed by the heat medium and the heat medium evaporates. The conditioned air is cooled through the heat exchange between the conditioned air and the heat medium in the evaporator 38. The cooled conditioned air is supplied into the vehicle compartment to cool the vehicle compartment. The heat medium evaporated in the evaporator 38 is drawn and compressed by the compressor 31 again and recirculates through the heat pump cycle 30.

On the other hand, as shown in FIG. 3, when the heat pump cycle 30 is operating in the heating mode, the heat medium flows through “the compressor 31, the inside radiator 32, the first expansion valve 34, the outside heat exchanger 35, and the compressor 31” in this order. In this case, in the heat pump cycle 30, the high-temperature high-pressure heat medium discharged from the compressor 31 flows into the inside radiator 32. At this time, heat of the heat medium flowing through the inside radiator 32 is released to the conditioned air through a heat exchange between the heat medium and the conditioned air, thereby heating the conditioned air. The heated air is supplied into the vehicle compartment to heat the vehicle compartment.

The heat medium having passed through the inside radiator 32 is decompressed by the first expansion valve 34 to have a low pressure and flows into the outside heat exchanger 35. The outside heat exchanger 35 serves as an evaporator when the heat pump cycle 30 is operating in the heating mode. That is, in the outside heat exchanger 35, heat exchange is performed between the heat medium circulating through the outside heat exchanger 35 and air flowing outside of the outside heat exchanger 35, so that heat of the air is absorbed by the heat medium and the heat medium evaporates. The heat medium evaporated in the outside heat exchanger 35 flows through the bypass passage W22, is drawn and compressed by the compressor 31 again, and recirculates through the heat pump cycle 30.

Next, structures of the radiator 25 and the outside heat exchanger 35 will be specifically described.

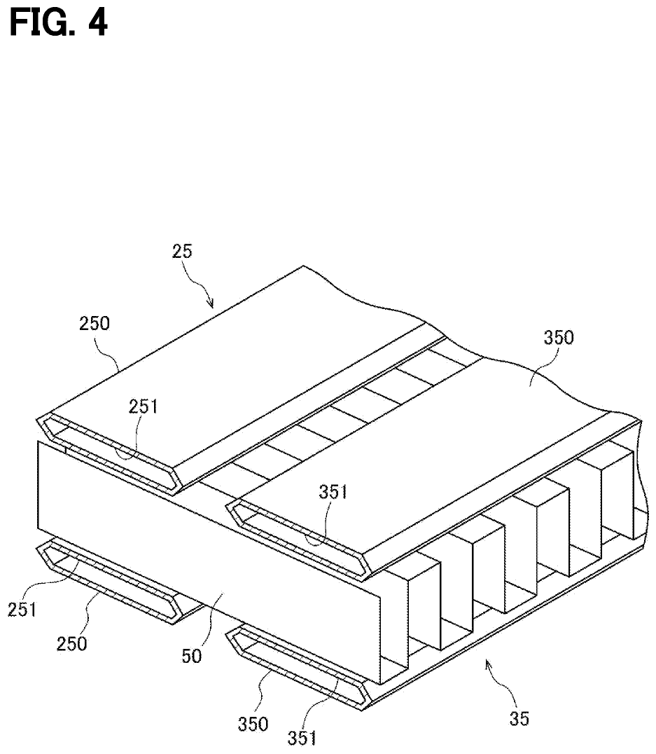

As shown in FIG. 4, the radiator 25 has a structure in which multiple flat tubes 250 are stacked at predetermined intervals. The tubes 250 are made of a metal such as an aluminum alloy. Each of the tubes 250 defines therein a passage 251 for the cooling water circulating through the cooling system 20. Gaps are defined between adjacent ones of the tubes 250 and air introduced through the grill opening 41 flows through the gaps. In the radiator 25, heat exchange is performed between the cooling water flowing through the tubes 250 and the air flowing outside of the tubes 250.

Similarly to the radiator 25, the outside heat exchanger 35 has a structure in which multiple flat tubes 350 are stacked at predetermined intervals. The tubes 350 are also made of a metal such as an aluminum alloy. Each of the tubes 350 defines therein a passage 351 for the heat medium circulating through the heat pump cycle 30. Gaps are defined between adjacent ones of the tubes 350 and air introduced through the grill opening 41 flows through the gaps. In the outside heat exchanger 35, heat exchange is performed between the heat medium flowing through the tubes 350 and the air flowing outside of the tubes 350.

Fins 50 are arranged in the gaps between the tubes 250 of the radiator 25 and in the gaps between the tubes 350 of the outside heat exchanger 35. Each of the fins 50 extends between the gap of adjacent ones of the tubes 250 of the radiator 25 and the gap of adjacent ones of the tubes 350 of the outside heat exchanger 35. Each of the fins 50 is a so-called corrugated fin formed by bending a thin metal plate into a wavy shape. The fins 50 are joined to the tubes 250 of the radiator 25 and the tubes 350 of the outside heat exchanger 35 by brazing or the like. The fins 50 increase contact areas of between the air and the radiator 25 and between the air and the outside heat exchanger 35 to increase heat transfer areas of the radiator 25 and the outside heat exchanger 35. As a result, heat exchange performances of the radiator 25 and the outside heat exchanger 35 can be improved.

The radiator 25 and the outside heat exchanger 35 are physically and thermally connected through the fins 50. That is, the radiator 25 and the outside heat exchanger 35 can transfer heat to and from each other through the fins 50. As described above, in the present embodiment, the fins 50 correspond to a connecting member that thermally connects between the radiator 25 and the outside heat exchanger 35.

On the other hand, as shown in FIG. 2, the heat exchange system 10 of the present embodiment further includes a shutter 60 and a blower 70.

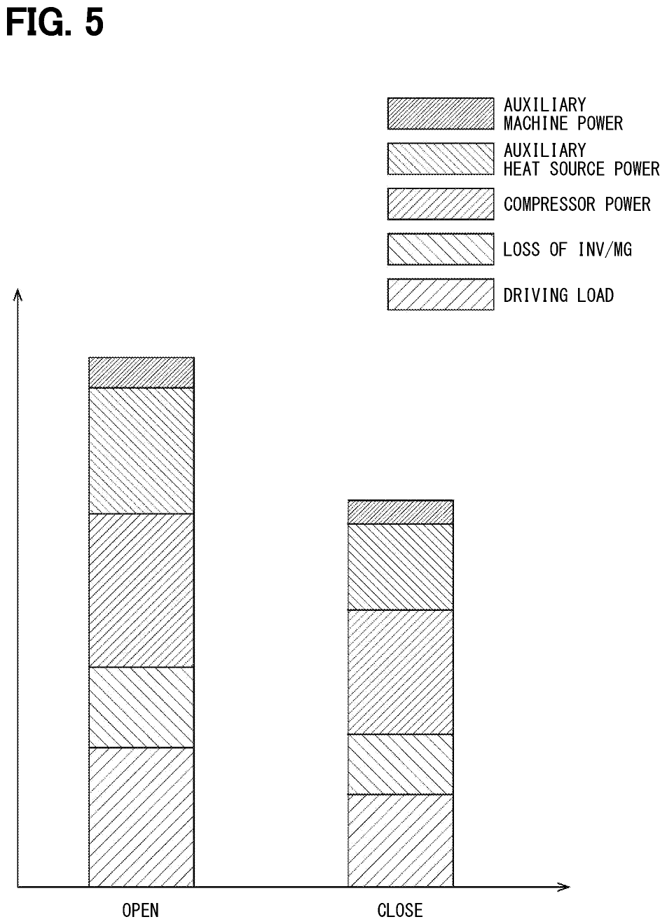

The shutter 60 is arranged in the grill opening 41. Thus, the shutter 60 is arranged at a position upstream of the radiator 25 and the outside heat exchanger 35 in the airflow direction Da. The shutter 60 has multiple blades. The shutter 60 is configured to open and close the grill opening 41 by moving the blades. When the shutter 60 is opened, air is introduced to the radiator 25, the outside heat exchanger 35, and the engine compartment 42 through the grill opening 41 as the vehicle travels. When the shutter 60 is closed, air is not introduced to the radiator 25, the outside heat exchanger 35, and the engine compartment 42 through the grill opening 41. In this way, the shutter 60 can selectively allow and forbid the air to flow to the radiator 25 and the outside heat exchanger 35. By closing the shutter 60, an aerodynamic performance of the vehicle can be improved, so that fuel efficiency of the vehicle can be improved. Specifically, aerodynamic drag of the vehicle when the shutter 60 is closed is less than aerodynamic drag of the vehicle when the shutter 60 is open, so that traveling load of the vehicle is reduced. As a result, as shown in FIG. 5, not only traveling load of the vehicle, but also electric powers of auxiliary machine, auxiliary heat source such as a PTC heater, and the compressor 31, and loss of the motor generator (MG) 21 and the inverter (INV) 23 mounted in the vehicle can be reduced.

The blower 70 is arranged at a position downstream of the radiator 25 and the outside heat exchanger 35 in the airflow direction Da. For example, when the vehicle is stopped or traveling at a low speed, an amount of air supplied to the radiator 25 and the outside heat exchanger 35 may be insufficient. In such case, the blower 70 supplies air to the radiator 25 and the outside heat exchanger 35 and supplements a lack of the air.

Next, an electrical configuration of the heat exchange system 10 of the present embodiment will be described.

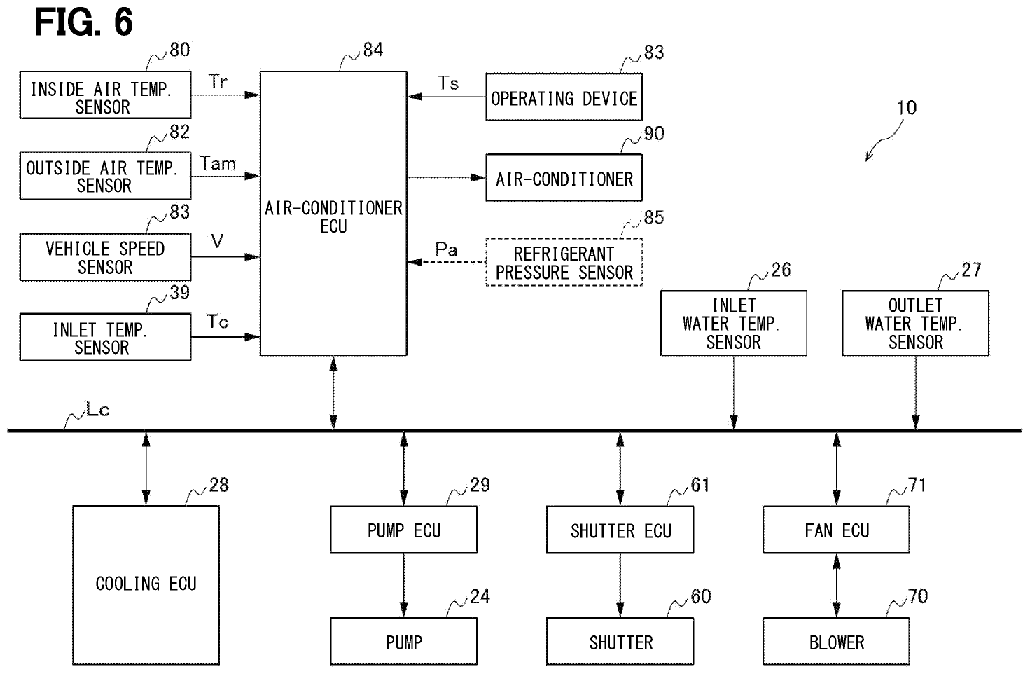

As shown in FIG. 6, the heat exchange system 10 of the present embodiment includes a cooling ECU (Electronic Control Unit) 28 configured to control the cooling system 20, an air-conditioner ECU 84 configured to control an air-conditioner 90 of the vehicle, a pump ECU 29 configured to control the pump 24, a shutter ECU 61 configured to control the shutter 60, and a fan ECU 71 configured to control the blower 70. Each of the ECUs 28, 29, 61, 71, and 84 is mainly composed of a microcomputer including a CPU, a memory, and the like, and configured to control a target device in an integrated manner.

Output signals from various sensors mounted in the cooling system 20 and the vehicle are input into the cooling ECU 28 through an in-vehicle network Lc. Examples of the sensors include an inlet water temperature sensor 26 and an outlet water temperature sensor 27. As shown in FIG. 1, the inlet water temperature sensor 26 is arranged in a pipe located at a position upstream of the radiator 25 in a flow direction of the cooling water. The inlet water temperature sensor 26 is configured to detect a temperature Tin of the cooling water to flow into the radiator 25 and output signals in accordance with the detected temperature Tin of the cooling water. The outlet water temperature sensor 27 is arranged in a pipe located at a position downstream of the radiator 25 in the flow direction of the cooling water. The outlet water temperature sensor 27 is configured to detect a temperature Tout of the cooling water flowing from the radiator 25 and output signals in accordance with the detected temperature Tout of the cooling water. In the following, for convenience, the temperature Tin of the cooling water detected by the inlet water temperature sensor 26 is referred to as “an inlet water temperature Tin” and the temperature Tout of the cooling water detected by the outlet water temperature sensor 27 is referred to as “an outlet water temperature Tout”.

The cooling ECU 28 is configured to acquire the inlet water temperature Tin and the outlet water temperature Tout based on output signals from the sensors 26, 27 and acquire state quantities required for controlling the cooling system 20 based on output signals from other sensors. The cooling ECU 28 is configured to transmit a control command value to the pump ECU 29 for controlling the pump 24 based on information acquired from the sensors. The pump ECU 29 is configured to control the pump 24 based on the control command value and perform a cooling control to cool the motor generator 21, the battery 22, and the inverter 23.

Output signals of various sensors mounted in the air-conditioner 90 and the vehicle are input into the air-conditioner ECU 84. Examples of the sensors include an inside air temperature sensor 80, an outside air temperature sensor 81, a vehicle speed sensor 82, and an inlet temperature sensor 39. The inside air temperature sensor 80 is configured to detect an inside temperature Tr that is a temperature inside of the vehicle compartment and output signals corresponding to the detected inside temperature Tr. The outside air temperature sensor 81 is configured to detect an outside temperature Tam that is a temperature outside of the vehicle compartment and output signals corresponding to the detected outside temperature Tam. The vehicle speed sensor 82 is configured to detect a speed V of the vehicle that is a speed at which the vehicle travels and output signals corresponding to the detected speed V. As shown in FIG. 1, the inlet temperature sensor 39 is configured to detect a temperature Tc of the heat medium to flow into the outside heat exchanger 35 and output signals corresponding to the detected temperature Tc of the detected heat medium.

Further, the air-conditioner ECU 84 is further configured to input signals transmitted from an operating device 83. The operating device 83 is a part operated by a user when operating the air-conditioner 90. The temperature in the vehicle compartment can be set with the operating device 83. The operating device 83 is configured to transmit information on a set temperature Ts in the vehicle compartment that is input by the user to the air-conditioner ECU 84.

The air-conditioner ECU 84 is configured to acquire information on the inside temperature Tr, the outside temperature Tam, and the speed V of the vehicle based on output signals from the sensors 80 to 82, and acquire various state quantities required for controlling the air-conditioner 90 based on output signals from other sensors. Further, the air-conditioner ECU 84 is configured to acquire various setting information set by the user from the operating device 83. The air-conditioner ECU 84 is configured to control the heat pump cycle 30 and the air-conditioner 90 based on the acquired information in an integrated manner.

The shutter ECU 61 is communicably connected to the cooling ECU 28 and the air-conditioner ECU 84 through the in-vehicle network Lc. The shutter ECU 61 can exchange various information with each of the ECUs 28, 29, 71, and 84 through the in-vehicle network Lc. The information exchanged between the ECUs 28, 29, 61, 71, and 84 is, for example, detecting values detected by the various sensors. Further, the cooling ECU 28 requests the shutter ECU 61 to open or close the shutter 60 based on an operating state of the cooling system 20. Further, the air-conditioner ECU 84 requests the shutter ECU 61 to open or close the shutter 60 based on an operating state of the heat pump cycle 30. The shutter ECU 61 is configured to control an opening/closing of the shutter 60 based on the requests from the cooling ECU 28 and the air-conditioner ECU 84. In this embodiment, the shutter ECU 61 corresponds to a controller.

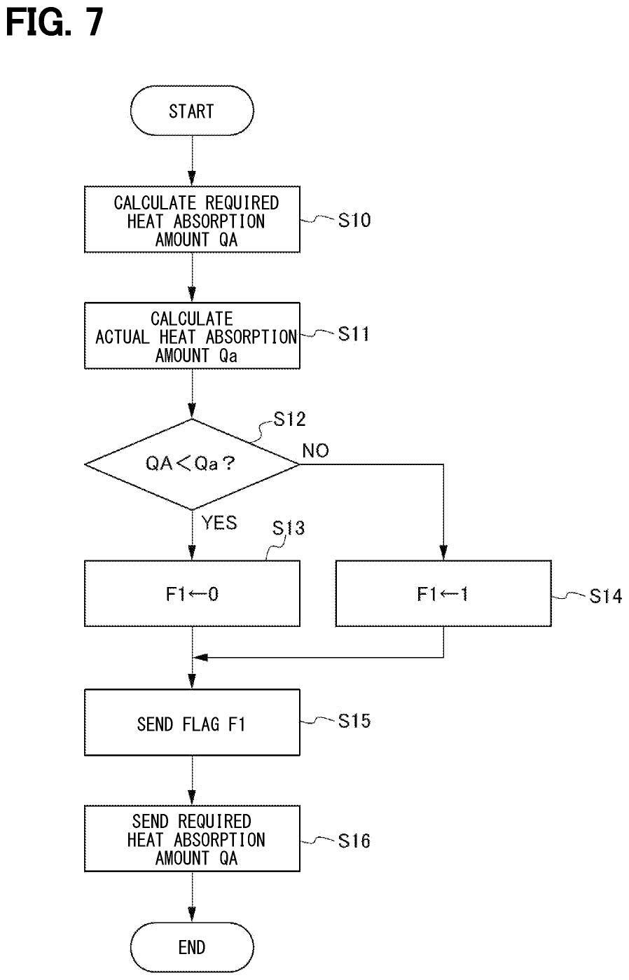

The fan ECU 71 is configured to control a rotational speed of the blower 70 based on requests from the cooling ECU 28 and the air-conditioner ECU 84. Further, the fan ECU 71 is configured to acquire a rotational speed Nf of the blower 70 from the blower 70. Next, a specific procedure of a request processing for opening and closing the shutter 60 that is executed by the cooling ECU 28 and the air-conditioner ECU 84 will be described. First, a procedure of a process executed by the air-conditioner ECU 84 will be described with reference to FIG. 7. The air-conditioner ECU 84 repeatedly executes the process shown in FIG. 7 at a predetermined cycle when the heat pump cycle 30 is operating in the heating mode.

As shown in FIG. 7, the air-conditioner ECU 84 first calculates a required heat absorption amount QA of the outside heat exchanger 35 in step S10. Specifically, the air-conditioner ECU 84 calculates, with a map and a calculation formula, a heat dissipation amount of the inside radiator 32 required to bring the inside temperature Tr closer to the set temperature Ts in the vehicle compartment based on a deviation between the set temperature Ts and the inside temperature Tr. The air-conditioner ECU 84 calculates the required heat absorption amount QA that is an amount of heat that the heat medium needs to absorb in the outside heat exchanger 35 from the calculated heat dissipation amount of the inside radiator 32 with a calculation formula, a map, and the like.

The air-conditioner ECU 84 calculates an actual heat absorption amount Qa that is a heat amount actually absorbed by the heat medium in the outside heat exchanger 35 in step S11 following step S10. The actual heat absorption amount Qa can be calculated in the following method.

The actual heat absorption amount Qa of the outside heat exchanger 35 can be calculated from a temperature difference ΔT that is a deviation between a temperature of the heat medium flowing through the outside heat exchanger 35 and the outside temperature Tam, and from an air amount GA supplied to the outside heat exchanger 35, with a formula and the like. Thus, the air-conditioner ECU 84 of the present embodiment acquires information on the outside air temperature Tam based on output signals from the outside air temperature sensor 81. Further, since the air-conditioner ECU 84 controls a rotational speed of the compressor 31 as the control of the heat pump cycle 30, the air-conditioner ECU 84 has the information on the rotational speed of the compressor 31. There is a correlation between the rotational speed of the compressor 31 and the temperature of the heat medium of the outside heat exchanger 35. The air-conditioner ECU 84 calculates the temperature of the heat medium of the outside heat exchanger 35 from the rotational speed of the compressor 31 with a calculation formula or a map showing the correlation therebetween. The air-conditioner ECU 84 calculates the temperature difference ΔT that is the deviation between the calculated temperature of the heat medium of the outside heat exchanger 35 and the outside temperature Tam. Further, the air-conditioner ECU 84 calculates the air amount GA blown to the outside heat exchanger 35 from the speed V of the vehicle and the rotational speed Nf of the blower 70 that can be acquired from the fan ECU 71. The air-conditioner ECU 84 calculates the actual heat absorption amount Qa of the outside heat exchanger 35 from the calculated temperature difference ΔT and the air amount GA blown to the outside heat exchanger 35 with a calculation formula or the like.

The air-conditioner ECU 84 determines whether the actual heat absorption amount Qa of the outside heat exchanger 35 is greater than the required heat absorption amount QA in step S12 following step S11. When the air-conditioner ECU 84 makes an affirmative decision in step S12, that is, when the actual heat absorption amount Qa of the outside heat exchanger 35 is greater than the required heat absorption amount QA, the air-conditioner ECU 84 determines that the heat absorption from the air in the outside heat exchanger 35 is not necessary. In this case, the air-conditioner ECU 84 sets a first request flag F1 to “0” in step S13 in order to request the shutter ECU 61 to close the shutter 60.

On the other hand, when the air-conditioner ECU 84 makes a denial determination in step S12, that is, when the actual heat absorption amount Qa of the outside heat exchanger 35 is less than or equal to the required heat absorption amount QA, the air-conditioner ECU 84 determines that heat absorption from the air is necessary in the outside heat exchanger 35. In this case, the air-conditioner ECU 84 sets the first request flag F1 to “1” in step S14 in order to request the shutter ECU 61 to open the shutter 60. After executing the process of step S13 or the process of step S14, the air-conditioner ECU 84 transmits the information on the first request flag F1 to the shutter ECU 61 in step S15. Subsequently, in step S16, the air-conditioner ECU 84 transmits the information on the required heat absorption amount QA to the shutter ECU 61, and then ends a series of the processes shown in FIG. 7.

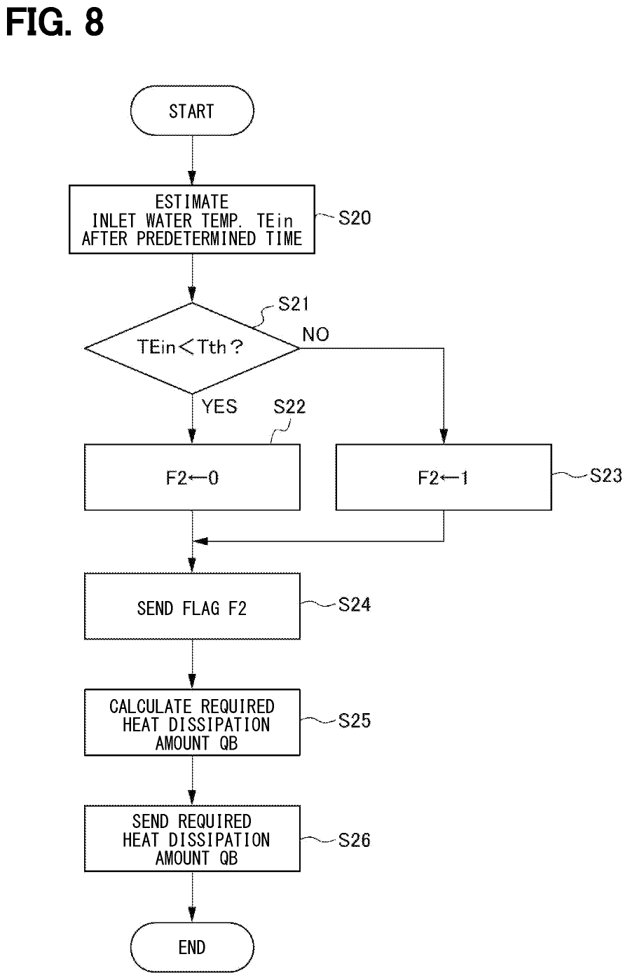

Next, the procedure of the process executed by the cooling ECU 28 will be described with reference to FIG. 8. The cooling ECU 28 repeatedly executes the process shown in FIG. 8 at a predetermined cycle.

As shown in FIG. 8, in step S20, the cooling ECU 28 calculates an estimated value TEin of an inlet water temperature, which is an estimated temperature of the cooling water to flow into the radiator 25 at a timing a predetermined period has passed from the present time. Specifically, the cooling ECU 28 determines a change rate of the inlet water temperature Tin per unit of time based on multiple values of the inlet water temperature Tin detected by the inlet water temperature sensor 26 before the predetermined period has passed from the present time. The cooling ECU 28 calculates the estimated value TEin of the inlet water temperature at a timing the predetermined period has passed, based on the calculated change rate of the inlet water temperature Tin per unit of time and the present inlet water temperature Tin detected by the inlet water temperature sensor 26. In this embodiment, the estimated value TEin of the inlet water temperature at a timing the predetermined period has passed corresponds to a temperature of the radiator 25 at a timing the predetermined period has passed.

In step S21 following step S20, the cooling ECU 28 determines whether the estimated value TEin of the inlet water temperature at a timing the predetermined period has passed is less than a predetermined temperature threshold Tth. The temperature threshold Tth is an upper limit of the inlet water temperature Tin required to maintain cooling states of the motor generator 21, the battery 22, and the inverter 23, which are cooling targets of the cooling system 20. The temperature threshold Tth is set in advance by experiments or the like and stored in the memory of the cooling ECU 28.

When the cooling ECU 28 makes an affirmative determination in step S21, that is when the estimated value TEin of the inlet water temperature at a timing the predetermined period has passed is less than the temperature threshold Tth, the cooling ECU 28 determines that a cooling capacity of the cooling system 20 is secured. In this case, the cooling ECU 28 sets a second request flag F2 to “0” in step S22 in order to request the shutter ECU 61 to close the shutter 60.

When the cooling ECU 28 makes a denial determination in step S21, that is, when the estimated value TEin of the inlet water temperature at a timing the predetermined period has passed is equal to or greater than the temperature threshold Tth, the cooling ECU 28 determines that the cooling capacity of the cooling system 20 is not secured. In this case, it is necessary to dissipate heat of the heat medium to the air in the radiator 25. Thus, the cooling ECU 28 sets the second request flag F2 to “1” in step S23 in order to request the shutter ECU 61 to open the shutter 60.

After executing the process of step S22 or the process of step S23, the cooling ECU 28 transmits information on the second request flag F2 to the shutter ECU 61 in step S24. Subsequently, the cooling ECU 28 calculates a required heat dissipation amount QB of the radiator 25 in step S25. Specifically, since the cooling ECU 28 controls the pump 24, the cooling ECU 28 has information on the rotational speed of the pump 24. The cooling ECU 28 calculates a flow rate of the cooling water flowing through the radiator 25 from the rotational speed of the pump 24 with a calculation formula or the like. Further, the cooling ECU 28 calculates a deviation between the inlet water temperature Tin and the outlet water temperature Tout of the radiator 25, and also calculates an actual dissipation amount of the radiator 25 from the calculated deviation and the flow rate of the cooling water flowing through the radiator 25 with a calculation formula and the like. The cooling ECU 28 calculates, from the actual dissipation amount of the radiator 25 and its trend, the required dissipation amount QB of the radiator 25 that is a heat amount required to be dissipated from the radiator 25 such that the inlet water temperature Tin of the radiator 25 does not reach a predetermined temperature. The predetermined temperature is an upper limit of the inlet water temperature Tin of the radiator 25 that can secure operations of the motor generator 21, the battery 22, and the inverter 23. The predetermined temperature is set in advance by experiments and the like.

In step S26 following step S25, the cooling ECU 28 transmits the information on the calculated required heat dissipation amount QB of the radiator 25 to the shutter ECU 61, and then ends a series of the process shown in FIG. 8.

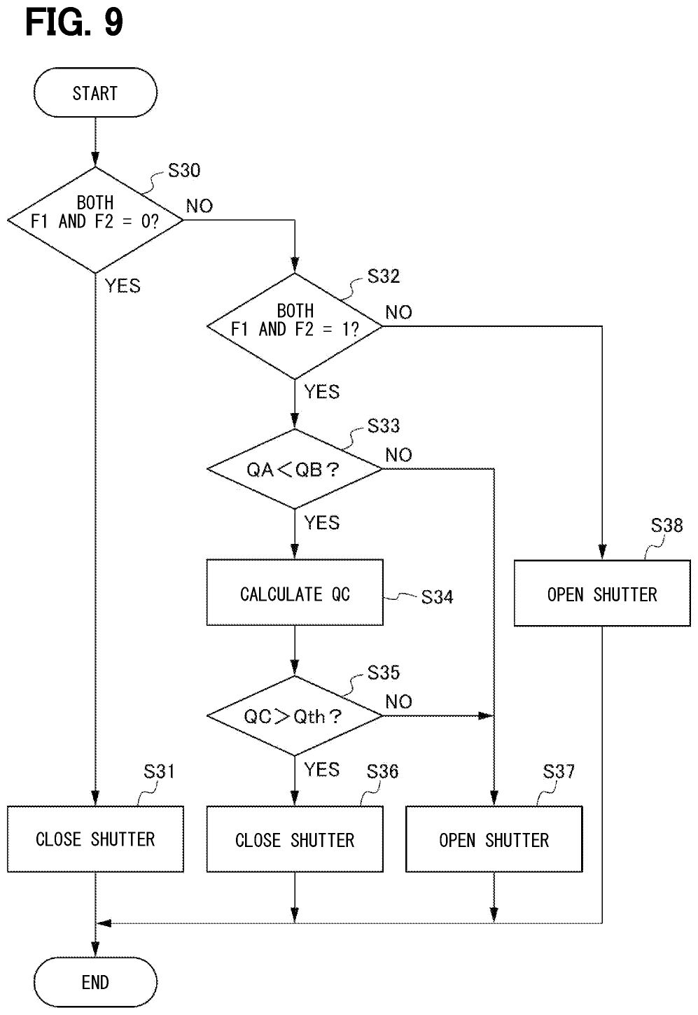

On the other hand, the shutter ECU 61 controls the shutter 60 to open and close based on the first request flag F1 transmitted from the air-conditioner ECU 84 and the second request flag F2 transmitted from the cooling ECU 28. Next, the procedure of the process executed by the shutter ECU 61 will be specifically described with reference to FIG. 9. The shutter ECU 61 repeatedly executes the process shown in FIG. 9 at a predetermined cycle.

As shown in FIG. 9, the shutter ECU 61 determines in step S30 whether both of the first request flag F1 transmitted from the air-conditioner ECU 84 and the second request flag F2 transmitted from the cooling ECU 28 are set to “0”. When both the first request flag F1 and the second request flag F2 are set to “0”, heat absorption of the outside heat exchanger 35 is not needed and heat dissipation of the radiator 25 is not needed. Thus, when both the first request flag F1 and the second request flag F2 are set to “0”, the shutter ECU 61 makes an affirmative determination in step S30, set the shutter 60 in a closed state in step S31, and ends the series of the process shown in FIG. 9. That the shutter 60 is in the closed state means that a part or all parts of the shutter 60 is closed.

When the shutter ECU 61 makes a denial determination in step S31, the shutter ECU 61 determines whether both the first request flag F1 and the second request flag F2 are set to “1” in step S32. When both the first request flag F1 and the second request flag F2 are set to “1”, heat absorption of the outside heat exchanger 35 is needed and heat dissipation of the radiator 25 is needed. Under this situation, the heat exchange system 10 of the present embodiment is configured to close the shutter 60 when the heat absorption of the outside heat exchanger 35 and the heat dissipation of the radiator 25 can be satisfied by a heat transfer between the radiator 25 and the outside heat exchanger 35 through the fins 50. As a result, a period in which the shutter 60 is closed can be extended and the aerodynamic performance of the vehicle can be improved.

Specifically, when both the first request flag F1 and the second request flag F2 are set to “1”, the shutter ECU 61 makes an affirmative determination in step S32 and determine whether the required dissipation amount QA of the outside heat exchanger 35 is less than the required heat dissipation amount QB of the radiator 25 in step S33. When the shutter ECU 61 makes a denial determination in step S32, that is, when the required heat absorption amount QA of the outside heat exchanger 35 is equal to or greater than the required heat dissipation amount QB of the radiator 25, the shutter ECU 61 controls the shutter 60 to open.

When the shutter ECU 61 makes an affirmative determination in step S33, that is, when the required heat absorption amount QA of the outside heat exchanger 35 is less than the required heat dissipation amount QB of the radiator 25, the shutter ECU 61 calculates a determination value based on the following equation f1 in step S34.

QC=QB—QA−α (f1)

A correction value α in the equation f1 is a heat amount that is lost through a heat transfer between the radiator 25 and the outside heat exchanger 35 through the fins 50. The correction value α includes, for example, an amount of heat released from the fins 50 to the air. The correction value α is obtained in advance by experiments and the like and stored in the memory of the shutter ECU 61. When the correction value α is negligibly small with respect to the required heat absorption amount QA and the required heat dissipation amount QB, the correction value α may be set to “0”.

The shutter ECU 61 determines whether the determination value QC is greater than a predetermined threshold Qth in step S35 following step S34. In the present embodiment, the process of step S35 corresponds to a process of determining whether the required heat absorption amount QA of the outside heat exchanger 35 can be supplemented by the required heat dissipation amount QB of the radiator 25. When the shutter ECU 61 makes an affirmative determination in step S35, that is, when the determination value QC is greater than the threshold Qth, the shutter ECU 61 determines that the required heat absorption amount QA of the outside heat exchanger 35 can be supplemented by the required heat dissipation amount QB of the radiator 25. In this case, the shutter ECU 61 controls the shutter 60 to close in step S36 and ends the series of the process shown in FIG. 9.

Further, when the shutter ECU 61 makes a denial determination in step S35, that is, when the determination value QC is less than or equal to the threshold Qth, the shutter ECU 61 determines that the required heat absorption amount QA of the outside heat exchanger 35 cannot be supplemented enough by the required heat dissipation amount QB of the radiator 25. In this case, the shutter ECU 61 controls the shutter 60 to open in step S37 and ends the series of the process shown in FIG. 9.

On the other hand, when the shutter ECU 61 makes a denial determination in step S32, that is, when either one of the first request flag F1 and the second request flag F2 is set to “1”, the shutter ECU 61 controls the shutter 60 to open in step S38 and ends a series of the process shown in FIG. 9.

According to the heat exchange system 10 of the present embodiment described above, advantages shown in the following (1) to (4) can be obtained.

(1) Since the radiator 25 and the outside heat exchanger 35 are thermally connected through the fins 50, the radiator 25 and the outside heat exchanger 35 can exchange heat therebetween. Thus, even if it is necessary to rotate the blower 70 to exchange heat between the radiator 25 and the outside heat exchanger 35, the rotational speed of the blower 70 can be slowed down. It is also possible to stop the blower 70 depending on the conditions. Therefore, power consumption can be reduced.

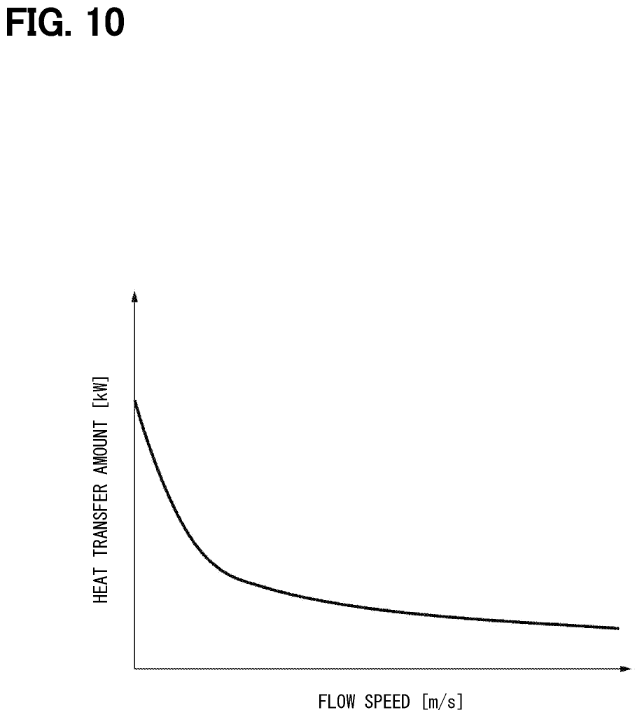

(2) If the vehicle does not include the shutter 60, air flows through the grill opening 41 and passes through the radiator 25 and the outside heat exchanger 35, so that heat of the radiator is dissipated to the air. Thus, heat of the radiator 25 is less likely to transfer to the outside heat exchanger 35. More specifically, as shown in FIG. 10, as the amount of air passing through the radiator 25 increases, the amount of heat transferred from the radiator 25 to the outside heat exchanger 35 decreases. In this regard, in the heat exchange system 10 of the present embodiment, when the outside heat exchanger 35 serves as an evaporator, in other words, when the outside heat exchanger 35 serves as a heat absorber that absorbs heat from the air, the shutter ECU 61 closes the shutter 60. When the shutter 60 is closed, air is prevented from flowing to the radiator 25 and the outside heat exchanger 35, so that heat of the radiator 25 is less likely to be dissipated to air. Therefore, the radiator 25 and the outside heat exchanger 35 can more efficiently exchange heat therebetween.

(3) When both the first request flag F1 and the second request flag F2 are set to “1”, and when the shutter ECU 61 determines that the determination value QC calculated by subtracting the required heat absorption amount QA of the outside heat exchanger 35 from the required dissipation amount QB of the radiator 25 is greater than the threshold Qth, the shutter ECU 61 controls the shutter 60 to close. As a result, when the required heat absorption amount QA of the outside heat exchanger 35 can be supplemented by the required heat dissipation amount QB of the radiator 25, the shutter 60 is closed, so that the period in which the shutter 60 is closed can be extended. As a result, the aerodynamic performance of the vehicle can be improved. Therefore, it is possible to improve the fuel efficiency of the vehicle and extend a driving range. It is also possible to extend a period in which the heat pump cycle 30 can operate in the heating mode.

(4) The shutter ECU 61 is configured to calculate the determination value QC by further subtracting the correction value α, which is set based on a heat dissipation amount of the fins 50, from a difference value calculated by subtracting the required heat absorption amount QA of the outside heat exchanger 35 from the required dissipation amount QB of the radiator 25. As a result, it is possible to calculate the determination value QC in consideration of the heat dissipation amount through the fins 50, so that it is possible to more accurately determine whether the shutter 60 can be closed.

### Second Embodiment

Next, a heat exchange system 10 of a second embodiment will be described. Hereinafter, differences from the heat exchange system 10 of the first embodiment will be mainly described.

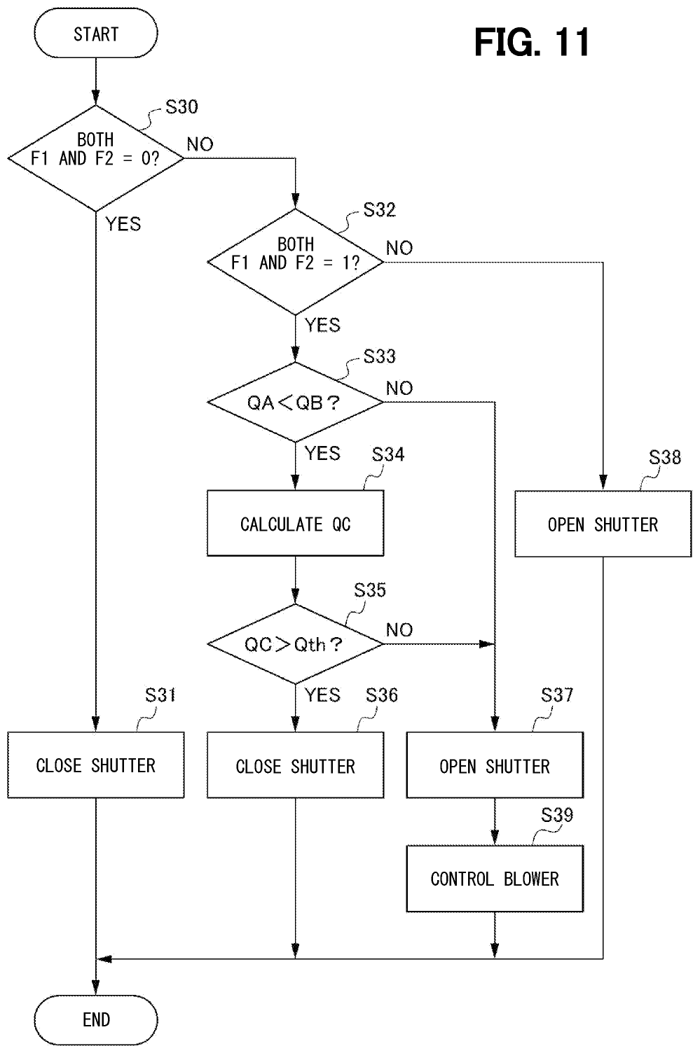

As shown in FIG. 11, the shutter ECU 61 controls the shutter 60 to open in step S37 and controls the blower 70 to operate by transmitting the control command value for the blower 70 to the fan ECU 71 in step S39. The process of step S39 is executed as follows.

The shutter ECU 61 transmits a duty value to the fan ECU 71 as the control command value for the blower 70. The fan ECU 71 controls the blower 70 based on the duty value. The duty value indicates an energization control amount of the blower 70. As the duty value increases, the energization amount of the blower 70 increases, so that the rotational speed of the blower 70 increases. On the other hand, as the duty value decreases, the energization amount of the blower 70 decreases, so that the rotational speed of the blower 70 decreases.

Further, the shutter ECU 61 calculates heat exchange amount QD between the radiator 25 and the outside heat exchanger 35. The heat exchange amount QD is calculated, for example, as follows. First, the shutter ECU 61 estimates the temperature of the radiator 25 based on the inlet water temperature Tin that is detected by the inlet water temperature sensor 26. Further, the shutter ECU 61 estimates the temperature of the outside heat exchanger 35 based on the temperature Tc of the refrigerant that is detected by the inlet temperature sensor 39. The shutter ECU 61 calculates a temperature difference between the estimated temperature of the radiator 25 and the estimated temperature of the outside heat exchanger 35, and calculates the heat exchange amount QD based on the calculated temperature difference. The shutter ECU 61 may estimate the temperature of the radiator 25 based on the outlet water temperature Tout that is detected by the outlet water temperature sensor 27. Further, when the heat exchange system 10 includes a sensor configured to detect the temperature of the refrigerant at a position downstream of the outside heat exchanger 35, the shutter ECU 61 may estimate the temperature of the outside heat exchanger 35 based on the temperature of the refrigerant that is detected by this sensor. Further, in place of the sensor configured to detect the temperature of the refrigerant, it is also possible to use a sensor configured to detect a pressure of the refrigerant.

Further, the shutter ECU 61 calculates a first subtracted value D1 by subtracting the heat exchange amount QD from the required heat absorption amount QA of the outside heat exchanger 35. The shutter ECU 61 has a map showing relationship between the heat absorption amount of the outside heat exchanger 35 and the duty value of the blower 70, and the shutter ECU 61 calculates a first duty value DA of the blower 70 from the first subtracted value D1 with this map.

Further, the shutter ECU 61 calculates a second subtracted value D2 by subtracting the heat exchange amount QD from the required heat dissipation amount QB of the radiator 25. The shutter ECU 61 has a map showing relationships between the heat dissipation amount of the radiator 25 and the duty value of the blower 70, and calculates a second duty value DB of the blower 70 from the second subtracted value D2 with this map.

The shutter ECU 61 sets larger one of the first duty value DA and the second duty value DB as the duty value DC of the blower 70, and sends the set duty value DC to the fan ECU 71 for controlling the blower 70.

According to the heat exchange system 10 of the present embodiment described above, advantages shown in (5) can be further obtained.

(5) When the shutter ECU 61 determines that the determination value QC is less than or equal to the threshold Qth, the shutter ECU 61 controls the shutter 60 to open and controls the blower 70 to operate based on the first subtracted value D1 calculated by subtracting the heat exchange amount QD from the required heat absorption amount QA of the outside heat exchanger 35 and the second subtracted value D2 calculated by subtracting the heat absorption amount QD from the required heat dissipation amount QB of the radiator 25. According to this configuration, as compared with the case where the blower 70 is driven based on the required absorption amount QA of the outside heat exchanger 35 and the required heat dissipation amount QB of the radiator 25, the rotational speed of the blower 70 can be slowed down while heat dissipation in the radiator 25 and heat absorption in the outside heat exchanger 35 are satisfied. Therefore, it is possible to reduce the power consumption.

### Third Embodiment

Next, a third embodiment of the heat exchange system 10 will be described. Hereinafter, differences from the heat exchange system 10 of the first embodiment will be mainly described.

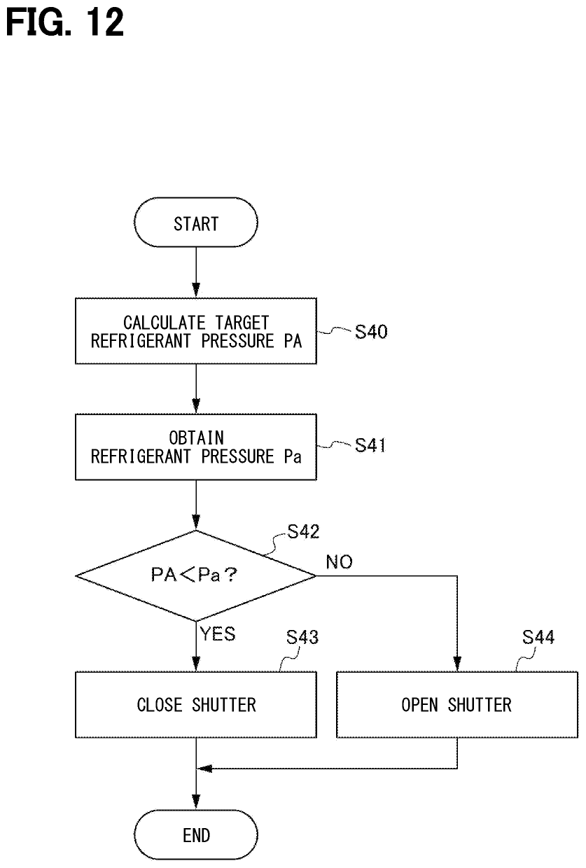

As shown in a broken line in FIG. 1, the heat exchange system 10 of the present embodiment includes a refrigerant pressure sensor 85 configured to detect a pressure Pa of the refrigerant flowing from the outside heat exchanger 35. In this embodiment, the refrigerant pressure sensor 85 corresponds to a sensor configured to detect the pressure of the refrigerant flowing through the outside heat exchanger 35. As shown in a broken line in FIG. 6, output signals from the refrigerant pressure sensor 85 are transmitted into the air-conditioner ECU 84. The air-conditioner ECU 84 is configured to execute a process shown in FIG. 12 based on the pressure Pa of the refrigerant detected by the refrigerant pressure sensor 85, the inside temperature Tr detected by the inside air temperature sensor 80, and the outside temperature Tam detected by the outside air temperature sensor 81.

As shown in FIG. 12, the air-conditioner ECU 84 first calculates a target refrigerant pressure PA in step S40. Specifically, the air-conditioner ECU 84 calculates a basic value PAb of the target refrigerant pressure from the outside temperature Tam using a map stored in the memory. In this map, the basic value PAb of the target refrigerant pressure increases as the outside temperature Tam increases. Further, the air-conditioner ECU 84 calculates a deviation ΔT (=Ts-Tr) between the set temperature Ts in the vehicle compartment and the inside temperature Tr, and calculates a correction value ΔPA for the target refrigerant pressure from the deviation ΔT based on the map stored in the memory. In this map, the correction value ΔPA increases as the deviation ΔT increases, and the correction value ΔPA decreases as the deviation ΔT decreases. The air-conditioner ECU 84 obtains a final target refrigerant pressure PA (=PAb+ΔPA) by adding the correction value ΔPA to the basic value PAb of the target refrigerant pressure.

The air-conditioner ECU 84 acquires information on an actual pressure Pa of the refrigerant in the outside heat exchanger 35 based on output signals from the refrigerant pressure sensor 85 in step S41 following step S40.

The air-conditioner ECU 84 determines whether the actual pressure Pa is greater than the target refrigerant pressure PA in step S42 following step S41. When the actual refrigerant pressure Pa is greater than the target refrigerant pressure PA, the air-conditioner ECU 84 makes an affirmative determination in step S42, and instructs the shutter ECU 61 to close the shutter 60 in step S43. On the other hand, when the actual pressure Pa is equal to or lower than the target pressure PA, the air-conditioner ECU 84 makes a denial determination in step S42, and instructs the shutter ECU 61 to open the shutter 60 in step S44. The shutter ECU 61 is configured to selectively open and close the shutter 60 based on the instruction from the air-conditioner ECU 84.

Next, an operation example of the heat exchange system 10 of the present embodiment will be described.

If the pressure Pa of the refrigerant in the outside heat exchanger 35 becomes too low, the outside heat exchanger 35 will frost. Thus, the target refrigerant pressure PA is set according to the outside temperature Tam. On the other hand, when the pressure Pa of the refrigerant in the outside heat exchanger 35 becomes too high, a temperature difference between the refrigerant in the outside heat exchanger 35 and the outside air Tam becomes too small. Thus, the heat absorption amount of the outside heat exchanger 35 decreases. When the amount of heat absorbed by the outside heat exchanger 35 from the outside air is small, the pressure Pa of the refrigerant in the outside heat exchanger 35 decreases, and when the amount of heat absorbed by the outside heat exchanger 35 from the outside air is large, the pressure Pa of the refrigerant in the outside heat exchanger 35 increases. That is, when the shutter 60 is open and a flow speed of the outside air supplied to the outside heat exchanger 35 increases, the pressure Pa of the refrigerant in the outside heat exchanger 35 increases. At this time, if the pressure Pa of the refrigerant in the outside heat exchanger 35 is higher than the target refrigerant pressure PA, the flow speed of the outside air supplied to the outside heat exchanger 35 can be slowed down, that is, the shutter 60 can be closed.

When the pressure Pa of the refrigerant in the outside heat exchanger 35 is higher than the target pressure PA, the rotational speed of the blower 70 may be decreased instead of closing the shutter 60.

According to the heat exchange system 10 of the present embodiment, it is not necessary to calculate the heat amounts QA, Qa, QB, and Qc used in the heat exchange system 10 of the first embodiment, so that calculation process can be simplified.

### OTHER EMBODIMENTS

The preceding embodiments may be practiced in the following modes.

In the heat exchange system 10 of each embodiment, the connecting member thermally connecting between the radiator 25 and the outside heat exchanger 35 is not limited to the fins 50 and may be another appropriate member.

The shutter 60 may be arranged in the air passage Wa extending from the grill opening 41 to the engine compartment 42. Further, the shutter 60 may be arranged at a position downstream of the outside heat exchanger 35 in the airflow direction.

The heat generating sources that are cooled by the cooling system 20 are not limited to the motor generator 21, the battery 22, and the inverter 23, ant may be another heat generating source mounted in the vehicle.

When the shutter ECU 61 of the first embodiment makes the denial determination in step S32 in FIG. 9, that is, when either one of the first request flag F1 and the second request flag F2 is set to “1”, the shutter ECU 61 may close the shutter 60.

The ECU and the control method thereof described in the present disclosure may be embodied with one or more special computer provided with at least one processor and at least one memory programmed to execute one or more functions embodied with a computer program. The control device and the control method described in the present disclosure may be embodied with a special computer provided with at least one processor that includes at least one special hardware logic circuit. The control device and the control method thereof described in the present disclosure may be embodied with at least one special computer provided with a combination of a processor and a memory programmed to implement one or more functions and at least one processor provided with at least one hardware logic circuit. The computer program may be stored, as instructions executable by a computer, in a tangible non-transitory computer-readable medium. The special hardware logic circuit and the hardware logic circuit may be embodied with a digital circuit including multiple logic circuits or may be embodied with an analog circuit.

When the configurations of the above embodiments are adopted for a vehicle powered by an electric motor such as an electric vehicle, the engine compartment 42 may be a space in which the electric motor is housed.

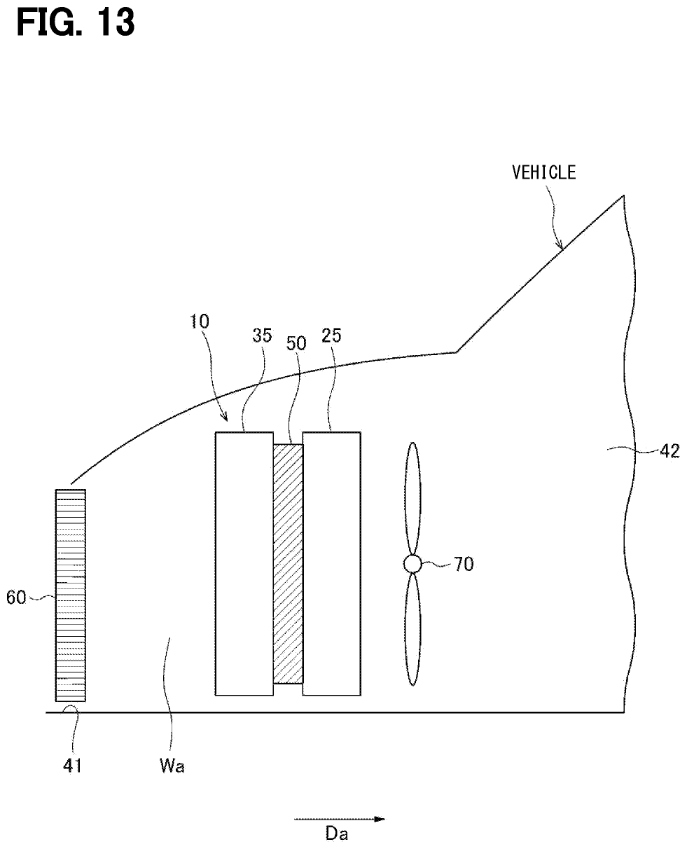

As shown in FIG. 13, the radiator 25 may be arranged at a position downstream of the outside heat exchanger 35 in the airflow direction Da. By the way, even if the shutter 60 is closed, there may be gaps between the blades of the shutter 60. Thus, a small amount of air may be flow into the engine compartment 42 through the gaps. When the fins 50 are not provided in the configuration shown in FIG. 13, it may be difficult to transfer heat of the radiator 25 to the outside heat exchanger 35 due to the airflow into the engine compartment 42 through the gaps. Specifically, when the radiator 25 is arranged at a position downstream of the outside heat exchanger 35 in the airflow direction Da as shown in FIG. 13, the air that has absorbed heat from the radiator 25 flows to the engine compartment 42 without through the outside heat exchanger 35. Thus, when the fins 50 are not provided, it is difficult to transfer heat of the radiator 25 to the outside heat exchanger 35. In this regard, when the radiator 25 and the outdoor heat exchanger 35 are thermally connected through the fins 50 as shown in FIG. 13, even if a small amount of air flows to the radiator 25 and the outside heat exchanger 35 while the shutter 60 is closed, heat of the radiator 25 can be transferred to the outside heat exchanger 35 through the fins 50.

In the process shown in steps S31 and S36 shown in FIGS. 9 and 11, the shutter 60 may be moved in a closing direction from a state of the shutter 60 in steps S37 and S38 instead of totally closing the shutter 60. The same applies to the process of step S43 of FIG. 12.

The outside heat exchanger 35 is not limited to the one used as a heat absorber that absorbs heat from air, and may be used as a radiator that dissipates heat to air.

The present disclosure is not limited to the specific examples described above. The specific examples described above which have been appropriately modified in design by those skilled in the art are also encompassed in the scope of the present disclosure so far as the modified specific examples have the features of the present disclosure. Each element included in each of the specific examples described above, and the placement, condition, shape, and the like of the element are not limited to those illustrated, and can be modified as appropriate. The combinations of the elements in each of the specific examples described above can be changed as appropriate, as long as it is not technically contradictory.

What is claimed is:

1. A heat exchange system comprising:
a heat exchanger for a heat exchange cycle of an air-conditioner of a vehicle, the heat exchanger being configured to exchange heat between a heat medium circulating through the heat exchange cycle and an air introduced from a front side of the vehicle into an engine compartment such that the heat medium absorbs heat from the air or dissipates heat to the air;
a radiator for a cooling system configured to cool a heat source in the vehicle, the radiator being configured to exchange heat between a cooling water for cooling the heat source in the vehicle and the air introduced from the front side of the vehicle into the engine compartment;
a connecting member thermally connecting between the heat exchanger and the radiator;
a shutter configured to selectively allow and prevent supply of air to the heat exchanger and the radiator; and
a controller configured to control the shutter to selectively open and close, wherein
a heat absorption amount of the heat exchanger required for the heat exchange cycle is defined as a required heat absorption amount,
a heat dissipation amount of the radiator required for the cooling system is defined as a required heat dissipation amount,
the controller is further configured to:
determine whether the required heat absorption amount can be supplemented by the required heat dissipation amount; and
control the shutter to move in a closing direction upon determining that the required heat absorption amount can be supplemented by the required heat dissipation amount.

2. The heat exchange system according to claim 1, wherein
a value calculated by subtracting the required heat absorption amount of the heat exchanger from the required heat dissipation amount of the radiator is defined as a determination value,
a heat amount actually absorbed by the heat exchanger is defined as an actual heat absorption amount of the heat exchanger,
the controller is further configured to:
determine whether the determination value is greater than a predetermined threshold when the actual heat absorption amount is less than or equal to the required heat absorption amount of the heat exchanger and a temperature of the radiator at a timing a predetermined period has passed is equal to or higher than a predetermined temperature, wherein
the controller is further configured to:
determine that the required heat absorption amount can be supplemented by the required heat dissipation amount upon determining that the determination value is greater than the predetermined threshold; and
control the shutter to move in the closing direction.

3. The heat exchange system according to claim 2, wherein
the controller is further configured to calculate the determination value by subtracting a correction value that is set based on a heat dissipation amount of the connecting member from a difference value calculated by subtracting the required heat absorption amount of the heat exchanger from the required heat dissipation amount of the radiator.

4. The heat exchange system according to claim 2, further comprising
a blower configured to supply air to the heat exchanger and the radiator, wherein
the controller is further configured to:
open the shutter, calculate a first subtracted value by subtracting a heat exchange amount between the radiator and the heat exchanger from the required heat absorption amount of the heat exchanger, and calculate a second subtracted value by subtracting the heat exchange amount between the radiator and the heat exchanger from the required heat dissipation amount of the radiator upon determining that the determination value is less than or equal to the predetermined threshold; and
control the blower based on either one of the first subtracted value and the second subtracted value.

5. A heat exchange system comprising:
a heat exchanger for a heat exchange cycle of an air-conditioner of a vehicle, the heat exchanger being configured to exchange heat between a heat medium circulating through the heat exchange cycle and an air introduced from a front side of the vehicle into an engine compartment such that the heat medium absorbs heat from the air or dissipates heat to the air;
a radiator for a cooling system configured to cool a heat source in the vehicle, the radiator being configured to exchange heat between a cooling water for cooling the heat source in the vehicle and the air introduced into the engine compartment from the front side of the vehicle;
a connecting member thermally connecting between the heat exchanger and the radiator;
a shutter configured to selectively allow and prevent supply of air to the heat exchanger and the radiator, and
a controller configured to control the shutter to selectively open and close, wherein
the controller is further configured to:
set a target pressure of the heat medium flowing through the heat exchanger based on an outside air temperature that is a temperature outside of a vehicle compartment and an inside air temperature that is a temperature inside of the vehicle compartment; and
control the shutter to move in a closing direction when a pressure of the heat medium flowing through the heat exchanger is greater than the target pressure.

6. The heat exchange system according to claim 1, wherein
the shutter is disposed in a grill opening of the vehicle or an air passage extending between the grill opening and the engine compartment.

7. The heat exchange system according to claim 1, wherein
the radiator is disposed at a position upstream of the heat exchanger in an airflow direction.

8. A controller for a heat exchange system including:
a heat exchanger for a heat exchange cycle of an air-conditioner of a vehicle, the heat exchanger being configured to exchange heat between a heat medium circulating through the heat exchange cycle and an air introduced from a front side of the vehicle into an engine compartment;
a radiator for a cooling system configured to cool a heat source in the vehicle, the radiator being configured to exchange heat between a cooling water for cooling the heat source in the vehicle and the air introduced from the front side of the vehicle into the engine compartment;
a connecting member configured to transfer heat between the heat exchanger and the radiator; and
a shutter configured to selectively allow and prevent supply of air to the heat exchanger and the radiator, the controller comprising:
one or more processors; and
a memory coupled to the one or more processors and storing instructions that, when executed by the one or more processors, cause the one or more processors to at least:
determine whether a required heat absorption amount of the heat exchanger for the heat exchange cycle can be supplemented by a required heat dissipation amount of the radiator for the cooling system, and
control the shutter to move in a closing direction upon determining that the required heat absorption amount can be supplemented by the required heat dissipation amount.
